(19) United States
(12) Patent Application Publication
(10) Pub. No.: US 2005/0223534 A1
(43) Pub. Date: Oct. 13, 2005

(54) Continuously coated copper shapes and method of manufacture

(76) Inventors: Joseph P. Depaola, Beaverdam, VA (US); Prentice Lee Ralston JR., Spotsylvania, VA (US); Robert Wayne Donovan, Mechanicsville, VA (US); Harvey Lee Parrish, Maidens, VA (US); Bobbie Wilson Strum, Midlothian, VA (US)

Correspondence Address: Arthur L. Girard, PC, 8310 Poplar Hollow Trail, Richmond, VA, 23235, US

(21) Appl. No.: 10/818,234

(22) Filed: Apr. 5, 2004

(51) Int. Cl. H02G 15/20

(52) U.S. Cl. 29/452; 29/458; 118/125

(57) ABSTRACT

A method for the continuous production of an elongated continuously extruded and in line polymer coated copper shape that comprises exposing an as extruded elongated copper shape to in line cooling with water covered by an inert gas before it reaches a polymer coating operation. Continuously extruded copper wire having an adherent in line applied polymer coating thereon is also described.

### FIELD OF THE INVENTION

The present invention relates to continuously extruded and polymer clad copper shapes and to methods for their production.

### BACKGROUND OF THE INVENTION

U.S. Pat. No. 5,151,147 issued Sep. 29, 1992 describes a method for the production of coated wire or other elongated articles that includes a means to form the wire or other elongated article, preferably a rotary extruder, in tandem with a polymer extruder that extrudes a polymer in tubular form about the periphery of the wire or elongated product using a vacuum to draw the polymer tube down onto the extruded wire. The apparatus described in this patent includes, at the exit of the rotary extruder, a relatively short cooling zone and suggests cooling the wire before applying the tubularly extruded polymeric coating. While this patent suggests that the process described therein is equally applicable to a variety of aluminum alloys and copper, it has been found that in the case of copper, a relatively short cooling zone, or for that matter even an extended cooling zone of the type described in the '147 patent is generally inadequate to provide sufficient cooling of an extruded copper wire or shape prior to polymer application resulting in charring of the polymer (due to the relatively higher extrusion temperatures achieved in the extrusion of copper) and furthermore that adhesion between the copper and an overapplied layer of polymer tends to be weak and unsatisfactory for use in the manufacture of transformers made from the coated wire. These inadequacies, particularly that related to polymer coating adhesion, have been attributed in the past to the formation of oxide on the surface of the copper between the rotary extruder and the polymer coating operation. However, attempts to solve the problem in accordance with the teachings of the '147 patent that uses an air cooling system and even the installation of wire brushes to remove the oxide from the surface of the extruded copper shape have all proven inadequate to sufficiently increase the adhesion of the polymer to the copper. Similarly, lengthening the air cooling zone has proven equally inadequate in reducing the temperature of the as extruded product sufficiently to permit in line polymer coating without charring the coating. In any sort of practically sized manufacturing operation. In fact, in the current commercial production of copper wire and the like the only commonly applied practice is to extrude the copper wire, coil it, let it cool and then apply the polymer in an off-line uncoiling, coating and recoiling operation.

Accordingly, there exists a need for the development of a process for the in-line coating of continuously extruded copper wire and other elongated copper shapes that, while utilizing the general approach of the '147 patent cools a copper product in a relatively short distance and eliminates any negative adhesion issues relative to the presence of a copper oxide on the surface of the as extruded shape or other adhesion reducing issues.

### OBJECT OF THE INVENTION

It is therefore an object of the present invention to provide a method for the continuous production of polymer coated elongated copper wire or other articles using the general method described in the '147 patent that allows for high speed processing of the extruded and coated article without charring of the overapplied polymer coating while yielding a product that exhibits satisfactory to excellent adhesion between the extruded copper shape and the overapplied polymer layer.

### SUMMARY OF THE INVENTION

According to the present invention, there is provided a method for the continuous production of an elongated continuously extruded and in line polymer coated copper shape that comprises exposing the as extruded elongated copper shape to an in line cooling mixture of water and an inert gas before it reaches a polymer coating operation.

### DESCRIPTION OF THE DRAWINGS

FIG. 1 is a schematic side view of a production line for continuously forming and coating an elongated article or wire in accordance with the prior art.

FIG. 2 is a schematic depiction of a cooling zone that is used between the extruder and the coating station shown in FIG. 1 in accordance with the present invention.

### DETAILED DESCRIPTION

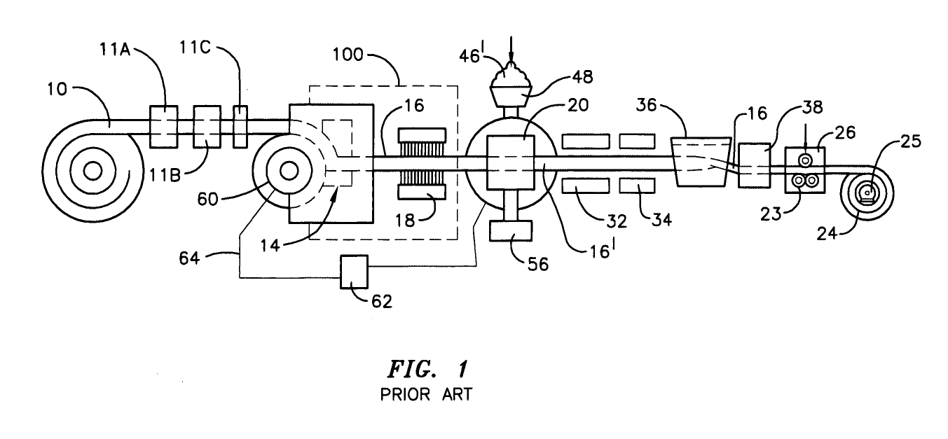

Referring now to FIG. 1 that depicts the prior art apparatus for the continuous extrusion and coating of an elongated copper wire or the like, a coil of metal feedstock, in the instant case copper, is passed through several successive treating units 11a for wire brushing, 11b for chemical treatment, and 11c for ultrasonic cleaning. A rotary extrusion press 12 receives the incoming treated metal feedstock and extrudes it continuously through a die 14 in the form of a bare metal wire 16. The orifice of die 14 determines the cross-sectional shape of the wire, that can be circular for some applications, including magnet wire, but may be rectangular in the case of magnet wire required to be wound compactly in an insulated coil connected to an electrical power source.

As set forth in the '147 patent the wire 16 as extruded is likely too hot for application of the polymer coating until it has been cooled by passing through a cooling unit 18, where a cooling medium such as air is blown against the wire. After being cooled, the wire passes into a die 20 for extruding plastic coating as shown in FIGS. 3 and 4 of the incorporated '147 patent. According to the description of the '147 patent, the wire continues through polymer extrusion die 20 which is of annular shape and extends around the wire so that the central axis of the die coincides with the central axis path of the path of wire 16 as it is drawn from extrusion die 14 over a roll 23 and onto a take-up roll 24. A motor 25 rotates roll 24 with sufficient force controlled by tension maintaining device 26, as to move wire 16 in a substantially straight and fixed path between die 14 and roll 23.

As shown in FIG. 1, bare wire 16 enters die 20, where it receives a polymer coating and becomes coated wire 16. The freshly coated wire preferably passes through a baking unit 32 to cure the polymer. It may then pass through an air-cooling zone 34 before passing through a cooling trough 36 where the wire is submerged in a cooling medium such as overflowing water by entering and leaving through weirs at the ends of the trough. The coated wire then passes through an insulation testing unit 38, and thence through the tension maintaining unit 26 onto roll 24. Various other elements of the apparatus of the '147 patent shown in FIG. 1 including motor 60, vacuum drawing unit 56 computer control means 62, 64 and 66 and polymer pellets 46 and pan 48 that are not of particular relevance to the instant invention are not further described herein, but reference can be readily made to the '147 patent for their detailed description.

It is in region 100 of FIG. 1 that the apparatus and method of the present invention find use as it is in this region that treatment of wire 16 in accordance with the present invention makes possible the fabrication of polymer coated copper wire or other elongated shapes that could not be practically fabricated using the apparatus and practices described in the '147 patent.

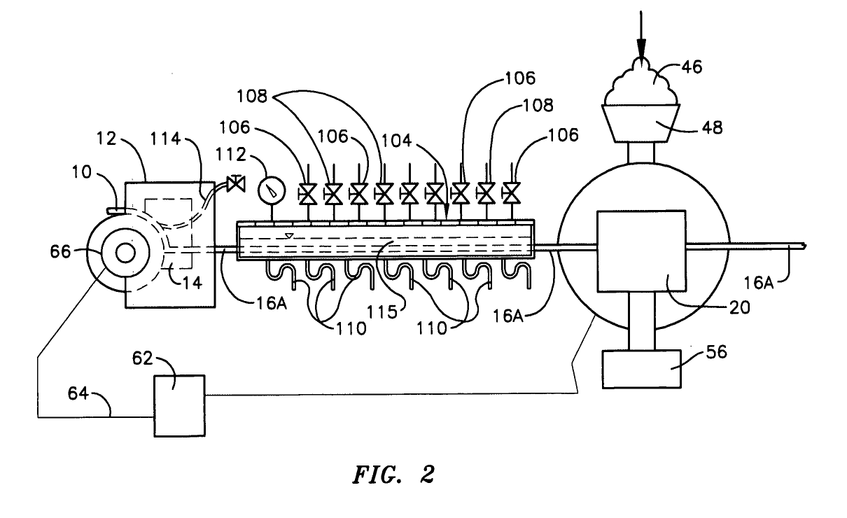

Referring now to FIG. 2, the area designated 100 in FIG. 1, that is the area between and including metal extrusion die 14 and polymer extrusion die 20, is the area of concentration for the application of the method of the present invention. It is in this area where controlled cooling of the extruded copper product coming out of the extrusion die 14 must be appropriately cooled, prior to entry into polymer extrusion die 20.

To accomplish this appropriate cooling, a trough 102 suitable for the containment of water and having a closeable and openable top 104, inert gas inlet valves 106 and water inlet valves 108 as well as water outlet drains 110 equipped with conventional traps 112 is provided. Regular tap water is fed through water inlet valves 108 from a normal commercial water tap is allowed to flow into trough 102 at a rate that provides for the maintenance of a water level above the level of extruded wire 16A that passes therethrough so that extruded wire 16A is immersed in the water 115 and an inert gas such as nitrogen, argon or the like is fed through gas inlet valves 106 at a pressure to insure displacement of any air in trough 102 and is allowed to escape through any openings or gaps in trough 102, for example around the edges of top 104. The pressure of the gas provided through gas inlet valves 106 as currently applied cannot be detected on a conventional gas pressure gauge 112 mounted in the wall of trough 102 and accordingly is apparently just slightly above ambient air pressure, although, as will be apparent to the skilled artisan, a higher gas pressure could be used without detriment to the instant process.

Simultaneously with the application of the above described inert gas/water trough treatment of wire 16A, inert gas is also used to shroud wire 16A as it is formed/extruded within die 14, but most importantly that it is shrouded as it exits die 14. Inert gas accesses the interior of die 14 through a valved aperture 114 in die 14. A peripheral groove about the interior of die 14 can be used to insure that the entire periphery of the extruded material is shrouded as it exits the die. Such a practice is known in the extrusion of certain aluminum alloys, and accordingly, the design of such an apparatus is well known in the art. Again, the pressure of the introduced inert gas is quite low being only adequate to provide shrouding of wire 16 as it is formed/extruded within die 14 and exits die 14.

According to a preferred practice of the present invention, copper rod 10 about one half inch in diameter is subjected to a hot water rinsing prior to its entry into die 14. Other pretreatments such as wire brushing, caustic wash etc. as described in the '147 patent have not been found necessary in our preferred practice. The preferred input rod for the method is a commercially available so-called “oxygen free” rod. The rod 10 is then extruded in the conventional fashion with the previously described inert gas shrouding and exits die 14 a temperature above about 1000° F. and preferably between about 1100° F. and 1200° F. As extruded wire/elongated shape 16 passes through the water/inert bath as described above, it is cooled to reach a temperature of between about 450° F. and 700° F. when it reaches the polymer extrusion die. Polymer is applied in the fashion described in the '147 patent.

Although a wide variety of polymeric materials can be applied to the wire/elongated shape, according to the preferred practice of the present invention for the manufacture of magnet wire useful particularly in the fabrication of high temperature transformers (180° C.+) the following polymers are preferred: Radel® R; Acudel®; and Hyfalon® the first two of which are polyphenylsulfones (of 180° C. and 220° C. capability respectively) and the third is a tetrafluoroethylene copolymer. All of these materials are commercially available from Solvay Advanced Polymers, LLC, 3702 Clanton Rd., Augusta, GA 30906.

The degree of adhesion of the polymer coating to the extruded copper material is to some extent a function of the temperature at which the polymer is coated on the copper. Coating temperatures of between about 450° F. and about 700° F. have been found satisfactory for the production of useful product.

There has thus been described a method for the continuous extrusion and coating of copper magnet wire or other elongated product that exhibits the ability to control the level of adhesion of the polymer coating to the copper product.

As the invention has been described, it will be apparent to those skilled in the art that the same may be varied in many ways without departing from the intended spirit and scope of the invention, and any and all such modifications are intended to be included within the scope of the appended claims.

1) In a process for the in line production of coated copper elongated shapes or wires by the continuous extrusion of copper wire in a die to form an extruded copper elongated shape or wire and the inline application of a polymer coating through the extrusion of a polymer over said copper elongated shape or wire, the improvement comprising:
a) performing said continuous extrusion of an extruded copper elongated shape or wire while introducing an inert gas into said die; and
b) cooling said extruded copper elongated shape or wire as it exits said die and before it reaches a point where said polymer coating is to a temperature sufficient to permit the attainment of adhesion between said extruded copper elongated shape or wire and the polymer coating without detrimental effect on the polymer coating.

2) The process of claim 1 wherein said extruded copper elongated shape or wire exits said die at a temperature above about 1000° F. and is cooled to a temperature between about 450° F. and about 700° F. prior to the application of the polymer coating.

3) The process of claim 1 wherein said cooling is performed by immersing said extruded copper elongated shape or wire in a trough containing flowing water covered by a layer of inert gas.

4) The process of claim 1 wherein said inert gas is selected from the group consisting of nitrogen and argon.

5) The process of claim 3 wherein said extruded copper elongated shape or wire exits said die at a temperature above about 1000° F. and is cooled to a temperature between about 450° F. and about 700° F. prior to the application of the polymer coating.

6) The process of claim 1 wherein said polymer is selected from the group consisting of poysulfones and tetrafluoroethylene copolymers.

7) A coated copper magnet wire produced by a process comprising:
A) continuously extruding a copper magnet wire by the continuous extrusion of a input copper wire in a die while introducing an inert gas into said die to form an extruded copper magnet wire;
B) cooling said extruded copper magnet wire to a predetermined temperature as it exits said die; and
C) continuously extruding a polymer on said continuously extruded and cooled magnet wire to provide a polymer coating;
wherein said cooling reduces the temperature of said extruded copper magnet wire to a temperature sufficient to permit the attainment of adhesion between said extruded copper magnet wire and the polymer coating without detrimental effect on the polymer coating.

8) The coated magnet wire of claim 7 wherein said extruded copper magnet wire exits said die at a temperature above about 1000° F. and is cooled to a temperature between about 450° F. and about 700° F. prior to the application of the polymer coating.

9) The coated magnet wire of claim 7 wherein said polymer is selected from the group consisting of poysulfones and tetrafluoroethylene copolymers.
